(19) United States
(12) Patent Application Publication
(10) Pub. No.: US 2017/0053210 A1
(43) Pub. Date: Feb. 23, 2017

(54) SMART HOME SYSTEM

(71) Applicant: THUY VAN T. DUONG, Ho Chi Minh City (VN)

(72) Inventor: THUY VAN T. DUONG, Ho Chi Minh City (VN)

(73) Assignee: TON DUC THANG UNIVERSITY, HO CHI MINH (VN)

(21) Appl. No.: 14/828,451

(22) Filed: Aug. 17, 2015

(51) Int. Cl. G06N 99/00; H04L 12/28

(52) U.S. Cl. CPC G06N 99/005; H04L 12/282

(57) ABSTRACT

A smart home system is disclosed which comprises a central camera system; a voice IP unit; a user identification system; a behavioral pattern data server; a plurality of sensors electrically coupled to operate each device based on the distance analysis with respect to each user; a central processing unit; a habit learning unit configured to analyze, interpret, and form a habitual usage profile for each user; and a central switching unit configured to operate each device following instructions from the central processing unit and the habit learning unit.

### FIELD OF THE INVENTION

The present invention relates generally to the field of electronic devices. More specifically, the present invention relates to a smart home system.

### BACKGROUND ART

Since the beginning of the twentieth energy, energy saving has been critical for sustainable development because of the explosive population growth. The majority of energy consumption is from home or office uses. The government policy including charging penalties for excessive energy usage does not solve the problem due to continuing population growth. Therefore, building smart homes has become the trend for both convenient living and energy saving.

The current prior-art smart home systems are based on scheduling schemes. In the scheduling schemes, the prior-art smart home systems are programmed by users to provide a fixed schedule for turning on or off some devices in the house. For example, the current prior-art smart home systems are programmed to turn on the lights, a backyard watering system, or air conditioners, etc. at a specified time of the day.

However, the current prior-art smart home systems are too rigid to adapt to users' change in behaviors or work schedules. In other words, the prior-art smart home systems do not based on user's habit at all, they are based on a fixed schedule provided by users. Thus, the current prior art smart home systems lack the capability of learning and relearning new habits. This results in inconveniences for users, continuing energy waste. More particularly, devices are continued to be turned on according to the old schedule even when the users do not want to use them or when users are not even home due to unexpected events. Furthermore, the current prior-art smart home systems do not provide automatic operations for all devices in the house; only a few selected devices can be programmed by the current prior-art smart homes. Yet, in the current prior-art smart home systems, old devices must be replaced in order to be programmed. Thus, the current prior-art smart home systems are costly and do not provide flexibility, energy saving, and quality of life for users.

Therefore what is needed is a smart home system that is capable of adapting to each user's habit and relearning new habits.

### SUMMARY OF THE INVENTION

Accordingly, an objective of the present invention is to provide a smart house that provides solutions to the problems described above. Thus, a method and a smart home system is disclosed which comprises a central camera system; a voice IP unit; a user identification system; a behavioral pattern data server; a plurality of sensors electrically coupled to operate each device based on the distance analysis with respect to each user; a central processing unit; a habit learning unit configured to analyze, interpret, and form a habitual usage profile for each user; and a central switching unit configured to operate each device following instructions from the central processing unit and the habit learning unit.

These advantages of the smart home of the present invention over the prior-art smart home systems can be listed in detail as followings:

Low costs.

Capability of operating each device in the house based on habit formed from data mining algorithm.

Capability of relearning and updating each user's newly formed habit.

Capability of using old devices without the need to buying new devices designed to be programmed by prior-art smart homes.

Capability of operating with all devices in the house.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a smart home system having a sensor connected to control each device and a habit learning unit in accordance with an embodiment of the present invention;

FIG. 2 is a system level schematic diagram illustrating a CPU, a central switching unit (CWU), and the sensors operating together to create the smart house system in accordance with an embodiment of the present invention;

FIG. 3 is a diagram illustrating the internal structure of the CPU and the behavior in accordance with an embodiment of the present invention;

FIG. 4 is a system level diagram illustrating the operation of the smart home system in accordance with an embodiment of the present invention;

FIG. 5. is a diagram illustrating structure of the sensor in accordance with an embodiment of the present invention;

FIG. 6 is a flow chart illustrating a method for providing a smart home system based on users' habits in accordance with an embodiment of the present invention;

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

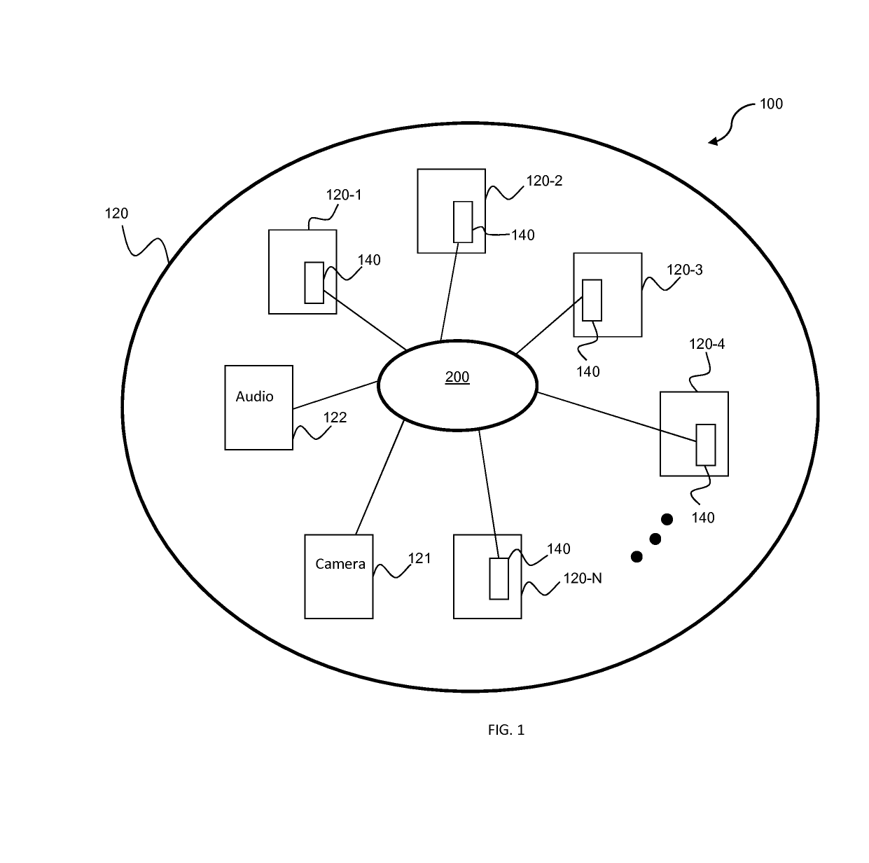

Referring now to FIG. 1 which illustrates a smart home 100 including devices 120-1 to 120-N and a smart home system 200. Each device, 120-1 to 120-N, is equipped with a sensor 140. Smart home system 200 is provided for a house 120. In the present invention, smart home system 200 is configured to operate each device 120-1 to 120-N according to each user's habit. In one example, devices 120-1 to 120-N includes, but is not limited to, a washing/drying machine 120-1, an air conditioner 120-2, a flat screen 120-3, a microwave oven 120-4, a refrigerator 120-5, a computer 120-6, and a desk lamp 120-7, etc. Sensor 140 is coupled to control each of the above-listed devices 120-1 to 120-N. A central camera system 121 and a microphone system 122 are also installed in smart home 100 of the present invention.

In on embodiment of the present invention, all electrically controlled water outlets, i.e., 120-7, such as touched faucets and timed sprinklers are also equipped with sensor 140. Smart home system 200 communicates to each sensor 140 to provide adaptive habitual usage profile for user and for each device 120-1 to 120-N. A habitual usage profile is a set of data reflecting a pattern of device usage over time of a particular user.

Continuing with FIG. 1, in operation, smart home system 200 observes and learns habitual usage profile of each user on each device. Then all devices 120-1 to 120-N are automatically turned on or off according to such habitual usage profile. For example, if a user A has the habit of studying at 7 p.m. every day during the week after dinner. Smart home system 200, after observing such habit of user A over a set period of time, automatically turns on desk lamp 120-6 and computer 120-5 for user A when he or she approaches those devices. If sensor 140 senses user A approaching at 7 p.m., sensor 140 sets device 120-5 and 120-6 to ready mode. In the ready mode, sensor 140 lets smart home system 200 takes control over devices 120-5 and 120-6 according to habitual usage profile of user A.

In another situation, for some reasons, if user A does not want to study and is not in the room at 7 p.m., sensor 140 is not connected to user A, sensor 140 thus takes control over smart home system 200 and keep those devices in the off states. In another exceptional situation, when user A comes home late and has dinner late. User A enters the study room 30 minutes late to study. Sensor 140 senses user A approaching and connected to devices 120-5 and 120-6, setting them to ready mode. In this situation, because smart home system 200 does not register this situation in the habitual usage profile, it lets user A turn on those devices by his or herself.

Continuing with FIG. 1, yet in another situation where user A has a habit of studying for 3 hours which is recorded in his or her habitual usage profile. Knowing this habitual usage profile, smart home system 200 automatically maintains those devices as long as user is still there. When user A leaves the room after 3 hours, devices 120-5 and 120-6 are set to a standby or sleep mode. Recognizing the stand-by mode, Smart home system 200 turns off devices 120-5 and 120-6 according to habitual usage profile of user A. However, in one exceptional case, user A leaves the room early because she or he does not have much homework that day, devices 120-5 and 120-6 are then set to stand-by mode and turned off before the specified hour (e.g., 11 p.m.) by sensor 140. Thus, energy is saved because of the smart home system 200.

Continuing again with FIG. 1, smart home system 200 is capable of relearning and updating a user's habitual usage profile in accordance with an embodiment of the present invention. In the above example, if user A continually does not enter the room to study, smart home system 200 learns new behavior and updates user A's habitual usage profile. Accordingly, computer 120-5 and desk lamp 120-6 are not turned on by smart home system 200 at the specified 7 p.m. Instead other device such as a game console, i.e., 120-8, is turned on at 7 p.m. in accordance with the new habitual usage profile of user A.

Please note that the above example is only an illustration of the habitual usage profile of user A on computer 120-5 and desk lamp 120-6. The above example does not limit the scope and capability of the present invention. Smart home system 200 of the present invention is capable to applying to every device in house 120 including sprinkler and water faucets for every user in house 120. Any device which can be controlled by sensor 140—whose structure and operation will be described later, is within the scope of the present invention.

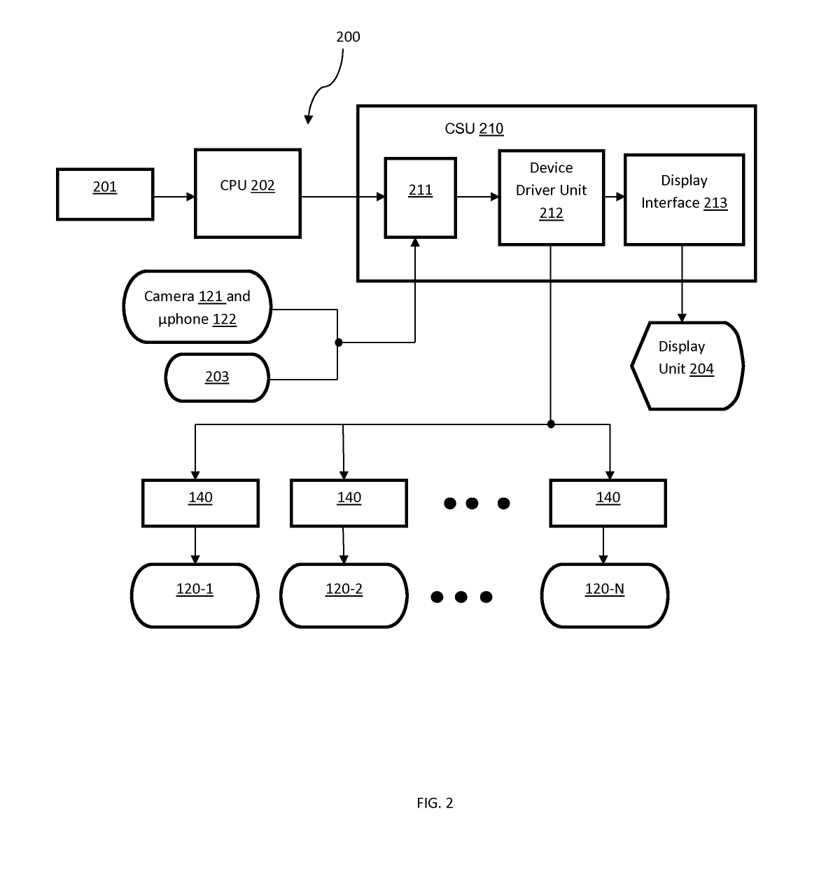

Next, referring to FIG. 2 which illustrates a system level schematic diagram of smart home system 200 in accordance with an embodiment of the present invention. Smart home system 200 includes a behavior pattern data server 201, a central processing unit 202, a central switching unit (CSU) 210, a display 204, central camera system 121, and an voice IP unit 203, all electrically connected together as shown in FIG. 2. Behavior pattern data server 201 is a database which stores all the time series device usage history of a user. Attributes of a user such as voice, image, RF identification are also stored in behavior pattern data server 201. In one embodiment, infrared profile of a user is also stored in behavior pattern data server 201. These attributes are assigned to each user's device usage history to determine the habitual usage profile. In other words, all device usage history and attributes of a user is stored in behavior pattern data server 201.

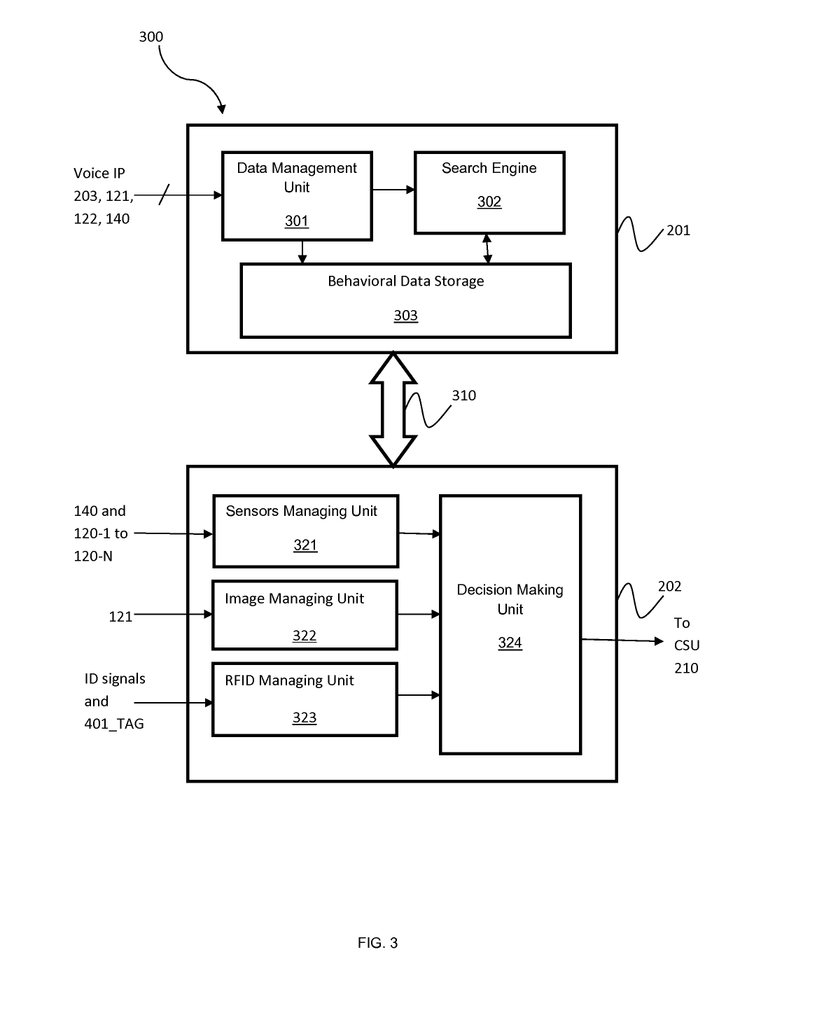

Continuing with the description of FIG. 2, CPU 202 is the brain of smart home system 200 of the present invention. The detail description of CPU is described later in the following FIG. 3-FIG. 6. CPU 202 learns the behavioral usage profile of each user and issues habitual operation commands to central switching unit 210. Upon receiving habitual operation commands, CSU 210 decodes these commands and switch these commands to appropriate devices 120-1 to 120-N according to each user's habitual usage profile. Next, based upon each device status set by sensor 140, CSU 210 turns on or turns off each device, 120-1 to 120-N, in accordance with habitual operation command from CPU 202. CSU 210 also includes a display interface 213 coupled to display system 204 to display the status of use for each device in house 120.

Next, referring to FIG. 3, a system level structure 300 of behavior pattern data server 201 in communication with CPU 202 is illustrated. Behavioral pattern data server 201 includes a data management unit 301, a search engine 302 and a memory 303. In one embodiment, memory 303 is flash memory. Data management unit 301 manages all data including user's attributes and device usage history. Data management unit 301 functions to organize and associate which device 120-1 to 120-N is used by which user. Data management unit 301 also maintains these data records in chronological order. Search engine 302 receives a search string from CPU 202. Search engine 302 looks into behavior data storage 303 to retrieve specific information for CPU 202.

Continuing with FIG. 3, CPU 202 includes sensors managing unit 321, image managing unit 322, RFID managing unit 323. CPU 202 then feeds these data into a decision making unit 324. In one embodiment, decision making unit 324 also includes a habit forming module which will be discussed in details later. As shown in FIG. 3, sensors managing unit 321 receives current usage information from devices 120-1 to 120-N and sensors 140. Similarly, image managing unit 322 receives and manages image pictures from each user in each room of house 120. RFID managing unit 323 receives and manages identification signals from each user. All of the information are fed into decision making unit 324 to learn the habit of a user and to formulate a behavior usage profile therein. Past usage history and attributes from each user are retrieved by CPU 202 from behavior pattern data server 201 via communication channel 310. CPU 202 and particularly decision making unit 324 combine past and present data usage for each user to formulate habit and/or update habit.

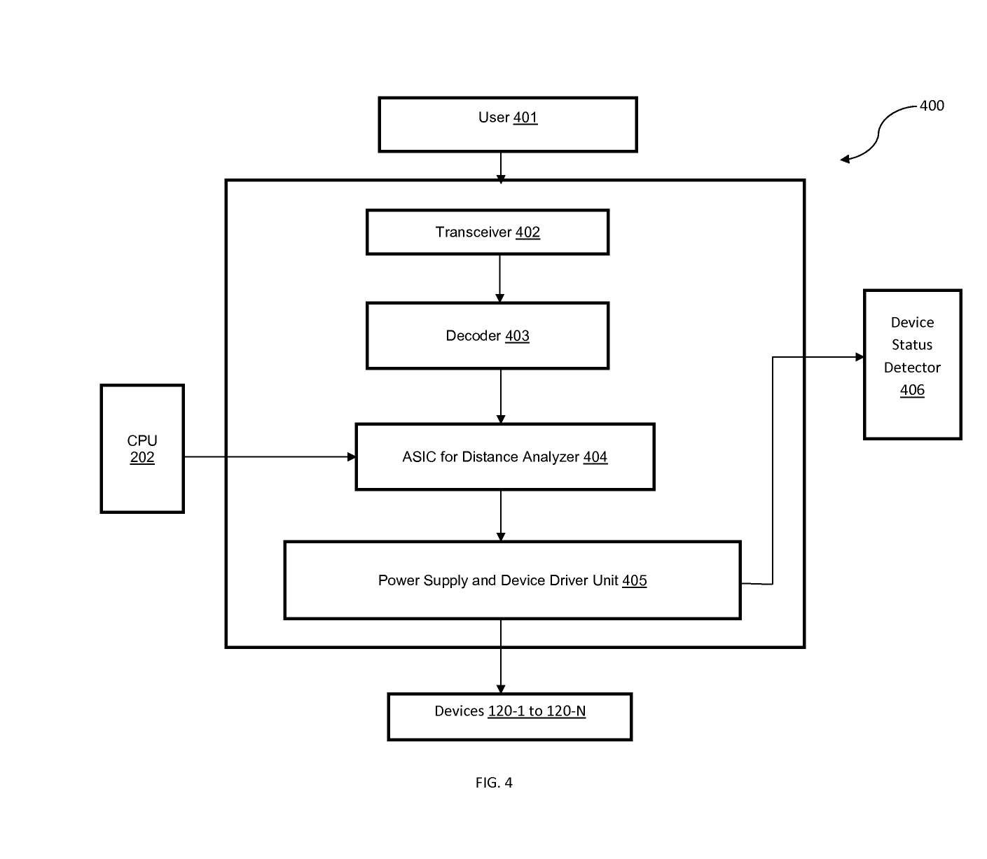

Referring now to FIG. 4 which illustrates the internal structure of sensor 140. More particularly, FIG. 4 depicts the relationship 400 between sensor 400 and CPU 202, devices 120-1 to 120-N, user 401 and a device status detector 406. Sensor 140 includes a transceiver 402 for receiving identification signal from user 401. Next, a decoder 403 receives the identification signal and assigns it to a particular user. Application Specific (ASIC) for distance analyzer 404 (hereinafter referred to as “ASIC 400”) measures the distance between user 401 and a device 120-1 to 120-N and then performs an analysis in order to set one of more modes for that particular device. Finally, ASIC 404 sends a command to a device driver unit 405 to either turn on or turn off that device. Device status detector 406 records how a particular device, 120-1 to 120-N, is used.

Continuing with FIG. 4, in operation, sensor 140 measures the distance between user 401 and device, 120-1 to 120-N via transceiver 402. Then, ASIC 404 compares this distance to a threshold distance d₀. The operating status of each device versus user 401 is summarized as follows.

When d is less than or equals to d₀ (d≦d₀), device, 120-1 to 120-N, is connected to user 401. If that particular device (i.e., 120-m, where 1≦m≦N) is ON, then sensor 140 sets device 120-m to an ON mode. On the other hand, if device 120-m is OFF, sensor 140 sets device 120-m to a READY mode. In the connected mode, user 401 has control over device 120-m in the ON mode and CPU 202 has control in the OFF mode.

When distance d is greater than d₀ (d>d₀), device 120-m is said to be disconnected to user 401. In this situation, if device 120-m is ON, sensor 140 sets device 120-m to a stand-by or sleep mode. Finally, if device 120-m is OFF, sensor 140 sets device 120-m to an OFF mode. In the “disconnected state”, sensor 140 always has priority and takes over the control of device 120-m. The above distance analysis is performed by ASIC 405 of the present invention.

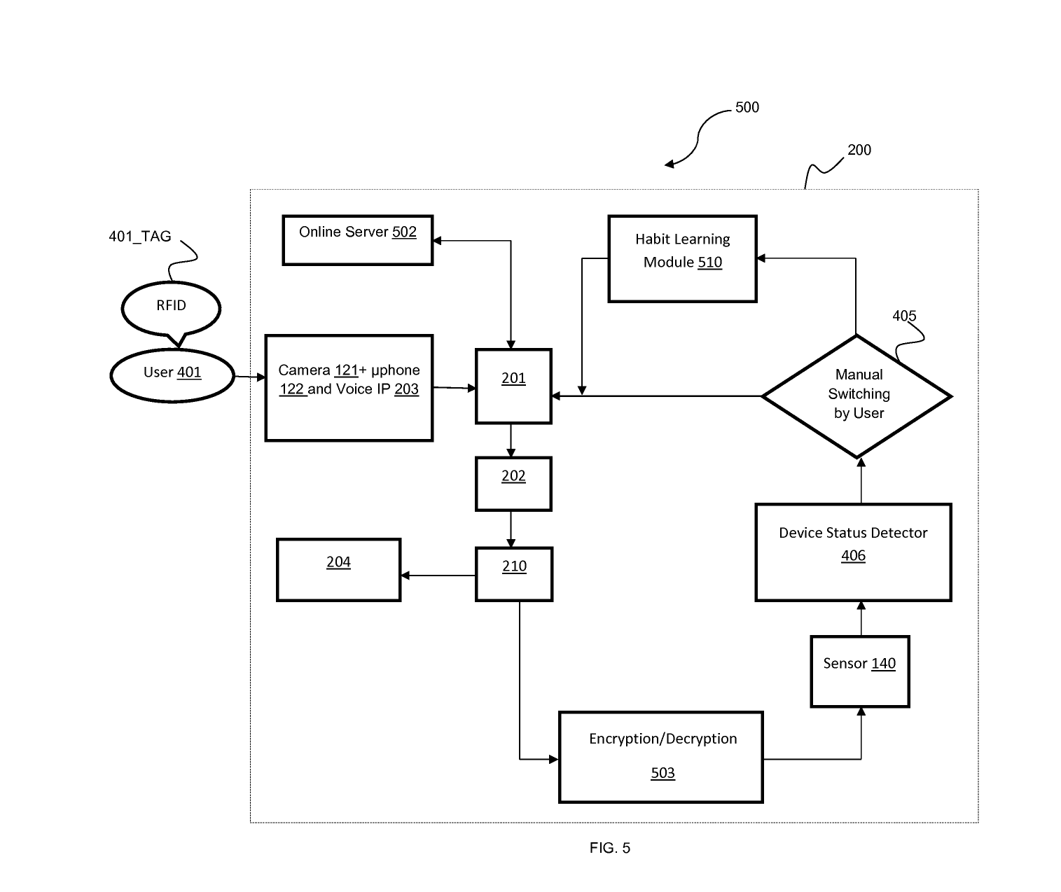

Next, referring to FIG. 5, a complete system level 500 of smart home system 200 interacting with user 401 wearing a RFID tag 401_TAG is illustrated. In one embodiment of the present invention, smart home system 200 includes a voice online server 502, a habit learning module 510, and a device status detector 406. Online voice server 502 is used to receive a user's voice command and transform it into a machine command that device 102-1 to 120-N can understand.

Referring again to FIG. 5, habit learning module 510 records a sequence of signals S₀ or S₁ from device status detector 406. S₀ represents a sequence of actions where the habitual operation command is performed according to habitual usage profile for each user, and S₁ represents a sequence of actions where the habitual operation commands from CPU 202 are overridden.

Continuing with FIG. 5, habit forming module 510 forms or modifies each user's habitual usage profile by counting and comparing the sequence S₁ with a preset constant K. If

$${\sum }_{i} {S}_{1 ij} > K ,$$

where j is an integer representing a user in house 120 and i is an integer representing the time a user j uses an device, then habit forming module 510 recognizes such action as a new habit. Thus, the habitual usage profile is reset. Then, CPU 202 issues a new habitual operation command series to central switching unit (CWU) 210 for that particular user j. On the other hand, if

$${\sum }_{i} {S}_{1 ij} < K ,$$

then habit forming module 510 maintains the same habitual usage profile for user j.

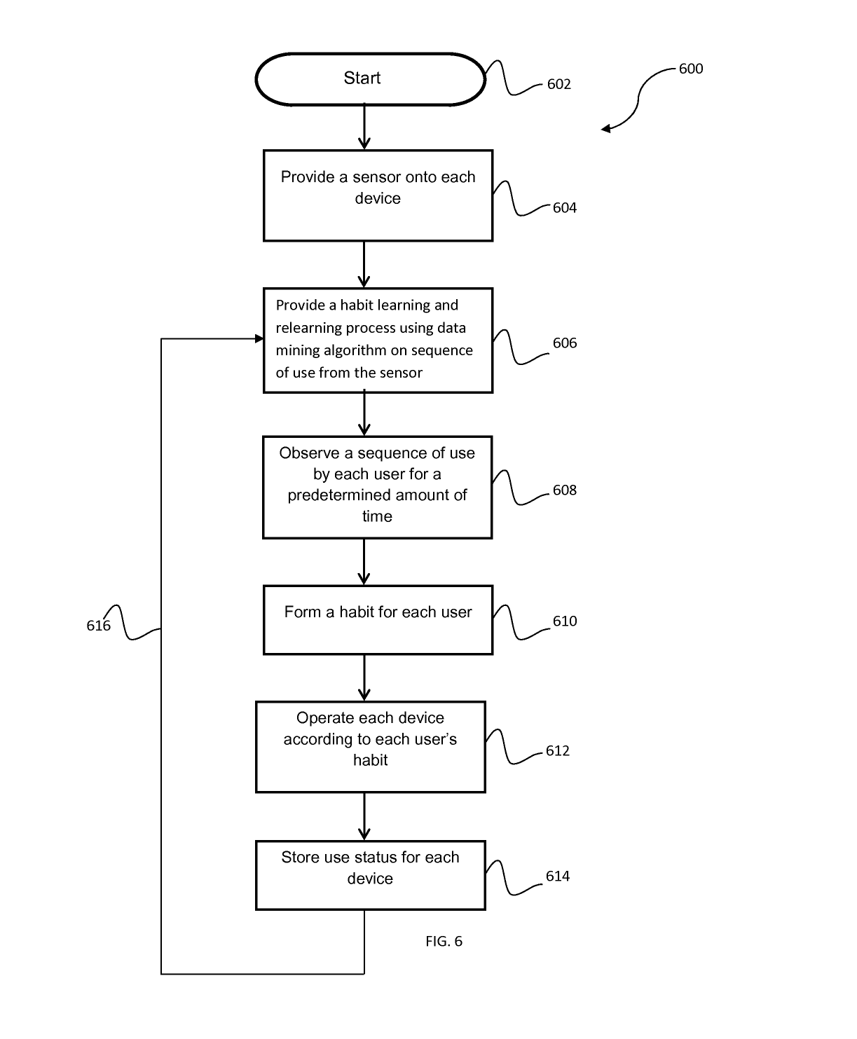

Now referring to FIG. 6, a method 600 for provide a smart home system 200 as described above is illustrated. Basically, method 600 provides sensor 140 to each device 120-1 to 120-N in smart home system 200. Then a data mining algorithm using a sequence of usage S₀ and S₁ is provided to learn and continually update habitual usage profile for each user 401.

At step 602, smart home system 200 in accordance with the present invention is started. Please note that smart home system 200 has the capability to use with all current devices 120-1 to 120-N without the need to purchase new devices. Step 602 is realized by collecting all the parts specified above for smart home system 200.

Then at step 604, a sensor is coupled to each device 120-1 to 120-N. Step 604 is realized by sensor 140 described in details above.

At step 606, a habit learning and relearning process using data mining algorithm performed on sequence of use by a user is provided. Step 606 is realized by CPU 202 in connection with central switching unit (CSU) 210, device status detector 406, habit forming module 510, and sensor 140 as described in FIG. 5 above.

At step 608, a sequence of device usage by each user is observed for a predetermined amount of time is provided. Step 608 is realized by behavioral pattern data server 201. In one embodiment, the predetermined time for observing a user's device usage is set to be 3 months.

Next, at step 610, a habit for each user is formed base on step 608 to establish a behavioral usage profile for each user. Step 610 is realized by data mining techniques on sequences S₀ and S₁ described in FIG. 5 above.

At step 612, each device, 120-1 to 120-N is operated based on habitual usage profile established in step 610 above. In practice, step 612 is realized by habitual operation commands issued by CPU 202 to central switching unit (CSU) 210.

Following is step 614, each time a user uses a device, such usage is recorded to establish new habitual usage profile. In other words, to learn a new habit from each user. Step 614 is realized by behavior pattern data server 201 described above.

Finally, steps 606 and 614 are repeated by means of step 616 in order to establish a habit for a user. Step 616 is realized and performed by smart home system 200 described above.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A smart home system, comprising:
a central camera system, located in different locations in a house, capable of observing each user in the house;
a user identification system, electrically coupled to said central camera system and said voice IP unit, configured to identify each user in the house;
a behavioral pattern data server configured to store usage pattern and attributes of each user;
a plurality of sensors, electrically coupled to the control circuit of each device in the house, operative to sense the distance between each user and a particular device, if the distance is smaller than a threshold distance, said plurality of sensors set that particular device to either a stand-by mode ready to be used by a user, and wherein if the distance is greater than said threshold distance, said plurality of sensors turns off that particular device;
a central processing unit, electrically coupled to said behavioral pattern data server, further comprising a habit learning module configured to analyze, interpret, and form a habitual usage profile for each user, wherein said central processing unit is operative to send out habitual operation commands according to said habitual usage profile; and
a central switching unit, electrically coupled to said central processing unit and each of device in the house, operative to either turn on or turn off particular devices according said habitual operation commands from said central processing unit, wherein said plurality of sensors override said habitual operation commands of said central processing unit and said central switching unit when the distance between said particular user and said device is greater than said threshold distance, and wherein in such instance said habit learning module relearns the habit and updates said habitual usage profile of each user if such overriding instance becomes a new habit of said user.

2. The smart home system of claim 1 further comprising a display unit electrically coupled to said central switching unit, configured to display and to monitor usage activities of each device in the house.

3. The smart home system of claim 1 further comprising a encryption/decryption unit, electrically coupled to said central switching unit, operative to inform said plurality of sensors an operating status of each device so that said plurality of sensors decide whether to override said operation commands from said central processing unit.

4. The smart home system of claim 3 wherein said user identification system further comprises an identification tag worn by each user.

5. The smart home system of claim 3 wherein said user identification system transmits an identification signal once every three seconds.

6. The smart home system of claim 1 wherein said habit learning module forms said habitual usage pattern for each user by using sequence pattern mining algorithm.

7. The smart home system of claim 1 wherein each of said plurality of sensors further comprises:
a transceiver for receiving said identification signal from a user;
a decode for recognizing said identification signal emitted from said user;
an application specific integrated unit (ASIC) including a distance measuring unit for measuring the distance between said user and said particular device using identification signals from said user, and a comparator for comparing the distance with said threshold distance; and
an device driver unit, electrically coupled to said control circuit of each device, operative to cause said device to said stand-by mode when the distance is less than said threshold distance, and to turn off said device vice versa.

9. The smart home system of claim 1 further comprising a device status detector electrically coupled to said plurality of sensors, operative to detect whether said habitual operation commands from said central processing unit are overridden.

10. The smart home system of claim 9 wherein said habit learning module records a sequence of signals S₀ or S₁ from said device status detector to form or modify said habitual usage pattern, wherein S₀ represents a sequence of actions where said operation command signal is performed according to said habitual usage profile for each user and S₁ represents a sequence of actions by a particular user where said habitual operation commands are overridden.

11. The smart home system of claim 10 wherein said sequence S₀ and S₁ further comprise number of usage per day, location of usage, and time of usage.

12. The smart home system of claim 11 wherein said habit forming module forms or modifies each user's habitual usage profile by counting and comparing said sequence S₁ with a preset constant K, if
$${\sum }_{i} {S}_{1 ij} > K ,$$
where j is an integer representing a user in the house and i is an integer representing each time a user j uses an device, then said habit forming module recognizes such action as new habit, resets said habitual usage profile, and issues a new habitual operation command series for that particular user j, and wherein if
$${\sum }_{i} {S}_{1 ij} < K ,$$
then said habit forming module maintains said habitual usage profile for said user j.

13. The smart home system of claim 1 wherein said central switching unit further comprises:
a receiving and filtering unit, electrically coupled to receive said habitual operation commands from said central processing unit, said image signals from said central camera system, or said commands from said voice IP unit;
a driver circuit, electrically coupled to turn on or turn off each device in the house in accordance with said operation commands from said central processing unit; and
a display interface, electrically coupled to said driver circuit, operable to enable said display unit to display all devices that are currently turned on by said driver circuit.

14. The smart home system of claim 1 wherein said behavior pattern data server further comprises:
a data management unit, electrically coupled to said central switching unit, operative to receive said image signals from said central camera system and said plurality of sensors;
a search engine, operable to said data management unit, operable to search for operation data from each user on each device; and
a data storage, electrically coupled to said data management unit, operative to store operation data and attributes of each user on each device.

15. The smart home system of claim 1 wherein said central processing unit further comprises:
an image signal management unit, electrically coupled to said central camera unit, operative to analyze image information from each user;
an identification signal management unit, electrically coupled to said identification unit, operable to identify each user;
a sensor management unit, electrically coupled to said device status detector, operable to record usage information from each user on different devices; and
decision making unit, electrically coupled to said image signal management unit, said identification signal management unit, and said sensor management unit, operable to decide whether to issue said habitual operation commands.

16. The smart home system of claim 1 wherein said plurality of sensors uses Bluetooth signals.

17. The smart home system of claim 1 further comprises a voice IP unit configured to transform each user's vocal commands into commands recognized by each device.

18. A method of providing a smart home capable of learning and updating user's habits, comprising:
providing a sensor on each device in the house;
providing a habit learning and relearning procedure based on outputs of said sensor;
observing a sequence of use by a particular for a predetermined amount of time;
forming a habit for each user; and
operating every device in the house in accordance with said habit.

19. The method of providing a smart home of claim 18 wherein said step of providing a sensor on each device further comprising:
electrically coupling said sensor to a control circuit of each device in the house;
sensing the distance between each user and said particular device, if the distance is smaller than a threshold distance, said sensor sets that particular device to on the stand-by mode ready to be used by a user, and wherein if the distance is greater than said threshold distance, said plurality of sensors turns off that particular device.

20. The method of providing a smart home wherein said step of providing a habit learning procedure based on outputs of said sensor further comprises updating said habitual usage profile based a sequence of state of use of each device by each user.
